(19) United States
(12) Patent Application Publication
(10) Pub. No.: US 2006/0042147 A1
(43) Pub. Date: Mar. 2, 2006

(54) INTERCHANGEABLE TROLLING SYSTEM

(76) Inventor: Richard T. Jenkins, Tavernier, FL (US)

Correspondence Address: MOORE & VAN ALLEN PLLC, P.O. BOX 13706, Research Triangle Park, NC, 27709, US

(21) Appl. No.: 10/907,966

(22) Filed: Apr. 22, 2005

Related U.S. Application Data
(60) Provisional application No. 60/606,292, filed on Sep. 1, 2004.

(51) Int. Cl. A01K 85/00

(52) U.S. Cl. 43/42.09; 43/42.28; 43/42.36

(57) ABSTRACT

A fishing lure for removal in part or in whole while a hook, fishing line, and leader assembly may remain intact. The lure includes a first member that is split into two or more parts with recessed areas that form an opening to receive the fishing line or leader when the first member is assembled. The first member may be assembled laterally around the line or leader, without threading the line or leader through the opening in the first member, eliminating the need to have a free end of line or to tie line to the lure. A second member may include a skirt collar and skirt or another type of lure part, or may be a sleeve. The second member may have a bore that allows axial passage of a hook, a slit that allows lateral passage of the line, or a combination thereof.

### CROSS-REFERENCE TO RELATED APPLICATIONS

This application claims priority from co-pending U.S. provisional application No. 60/606,292, filed Sep. 1, 2004, by the inventor hereof, the entire disclosure of which is incorporated herein by reference.

### BACKGROUND

The present invention relates to the field of fishing apparatus, and more particularly concerns fishing lures having interchangeable heads, rear portions, or combination thereof.

Conventional fishing lures are provided in a variety of sizes, shapes, and colors in an effort to optimize attracting fish, for any given type of fish, time of day, brightness, temperature, and so forth. Lures are commonly attached to the fishing line with a leader and are tied to the leader. To remove a lure requires cutting the leader; to replace the lure requires tying the leader to another lure. Such effort is burdensome and time consuming. The longer it takes to change a lure means the less time that the line can be in the water to catch fish.

In trying to identify a preferred lure at a particular time, it may be desirable to switch lures periodically until one is found that is successful at getting fish to bite. Or, if one person's lure is achieving fish strikes while others are not, other people fishing may want to switch to that lure. With conventional lures that have a permanently connected body that is tied to the leader, the time consuming process of lure change-out must be performed. Some lures, however, have heads that are separable from rear sections. The heads may be removed, rear sections may be removed, or both, while the leader and hook remain intact. Such lures are frequently complicated in design, difficult to assemble, or are poorly constructed to withstand the forces that a biting fish might apply.

Accordingly, there exists a need for a lure having interchangeable heads and rear sections that is designed for relatively rapid removal and replacement, as well as strength. Ideally, the new lure may be partially or completely removed from the line or leader without disassembling the line, leader, or hook.

### SUMMARY

In accordance with an embodiment of the present invention, a fishing lure for a fishing line or leader includes a first member including at least two parts. The parts include opposing surfaces having opposing recesses adapted to receive the fishing line or leader. The parts also include opposing portions that form a threaded cylindrical end of the first member, and the first member may be laterally applied to and removed from the fishing line or leader. A second member has a threaded bore, and the second member and the threaded end of the first member may be screwed together to secure the parts in close and complementary registration and unscrewed to release the parts and opposing surfaces. There may be hollow portions of at least one part of the first member and a ballast insert may be provided.

In accordance with another embodiment of the present invention, a fishing lure for a fishing line or leader includes a head with two parts. Each part includes a substantially flat surface, a substantially semicircular surface, and two ends. Each flat surface has a substantially longitudinal semicircular recess, and one end of each part is threaded. The flat surfaces oppose each other to assemble the head and to form substantially a cylinder with the semicircular surfaces, a substantially axial cylindrical opening with the semicircular recesses, and a threaded cylindrical end. The cylindrical opening is sized such that an eyelet fastened to the fishing line, an eyelet of the leader, or an eyelet of the hook cannot pass therethrough. The head may be laterally applied to and removed from the fishing line or leader. A rear portion including a cylindrical skirt collar has an axial, threaded bore and a skirt or tail, wherein the collar and the threaded end of the first member are screwed together to secure the parts in close and complementary registration and unscrewed to release the parts.

In accordance with another embodiment of the present invention, a fishing lure for a fishing line or leader includes a rear portion including two parts and a skirt or tail. Each part includes a substantially flat surface, a substantially semicircular surface, and two ends. Each flat surface has a longitudinal substantially semicircular recess. One end of each part is threaded. The flat surfaces oppose each other to assemble the rear portion and to form substantially a cylinder with the semicircular surfaces, a substantially axial cylindrical opening with the semicircular recesses, and a threaded cylindrical end. The cylindrical opening is sized such that an eyelet fastened to the fishing line, an eyelet of the leader, an eyelet of the hook, or combination thereof cannot pass therethrough. A head is provided that has an axial, threaded bore. The rear portion may be laterally applied to and removed from the fishing line or leader. The head and the threaded end of the rear portion are screwed together to secure the parts, in close and complementary registration and unscrewed to release the parts and opposing surfaces.

In accordance with another embodiment of the present invention, a method of making a fishing lure to be applied to fishing line or a fishing leader is provided. The method includes providing a first member having a longitudinal axis and at least one cylindrical end and threading the at least one cylindrical end of the first member. An opening is formed along the longitudinal axis. The first member is cut into at least two parts along the longitudinal axis. A second member is provided that has a bore and two ends, and the bore is threaded.

In accordance with another embodiment of the present invention, a method of attaching a fishing lure to a fishing line or leader is provided. The method includes laterally placing around the fishing line or leader a first member including at least two parts. The first member includes opposing surfaces having opposing recesses adapted to receive the fishing line or leader. The two parts include opposing portions that form a threaded cylindrical end of the first member. A second member having a threaded bore is placed around the fishing line or leader. The threaded end of the first member and the second member are screwed together, securing the parts in close and complementary registration.

Features and advantages of the present invention will become more apparent in light of the following detailed description of some embodiments thereof, as illustrated in the accompanying figures. As will be realized, the invention is capable of modifications in various respects, all without departing from the invention. Accordingly, the drawings and the description are to be regarded as illustrative in nature, and not as restrictive.

### BRIEF DESCRIPTION OF THE DRAWINGS

FIG. 1 is a perspective view of an embodiment of a fishing lure according to the present invention.

FIG. 2 is an exploded perspective view of the fishing lure of FIG. 1.

FIG. 3 is a perspective view of a head of the fishing lure of FIG. 1.

FIG. 4 is an exploded perspective view of the head of the fishing lure of FIG. 1.

FIG. 5 is an end elevation view of the head of FIG. 1.

FIG. 6 is a partial section view taken along line 6-6 of FIG. 1.

FIG. 7 is another embodiment of a head for a fishing lure according to the present invention.

FIG. 8 is an end elevation view of the head of FIG. 7.

FIG. 9 is a partial section view of another embodiment of a fishing lure according to the present invention.

FIGS. 10-13 are other embodiments of heads for fishing lures according to the present invention.

FIGS. 14 and 15 are exploded views of another embodiment of a head for a fishing lure according to the present invention.

FIG. 16 is a section view of another embodiment of a fishing lure according to the present invention.

### DESCRIPTION

In the Figures herein, unique features receive unique reference numerals, while features that are the same in more than one drawing receive the same reference numerals throughout. Further, certain terms of orientation may be used, such as “forward,” “rear,” “inner,” “outer,” “top,” “bottom,” “left,” and “right.” These terms are generally for convenience of reference, and should be so understood unless a particular embodiment requires otherwise.

The scope of the invention is not intended to be limited by materials listed herein, but may be carried out using any materials that allow construction and operation. Materials and dimensions depend on the particular application. In general the materials of the components may be metal, and selectively may be plastic, such as, in hard plastic components, LEXAN® brand polycarbonate resin, all as known by one of ordinary skill in the art (LEXAN is a registered trademark of General Electric Company Corporation).

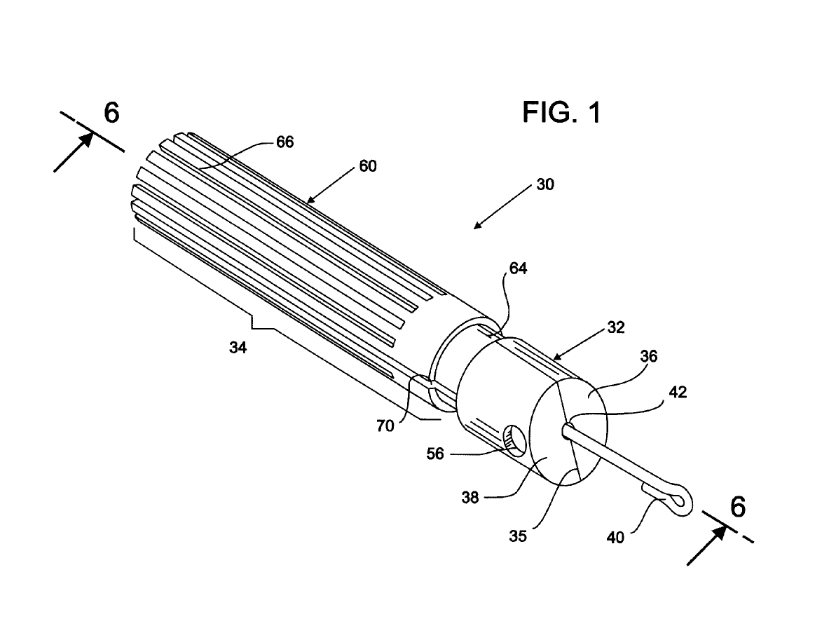

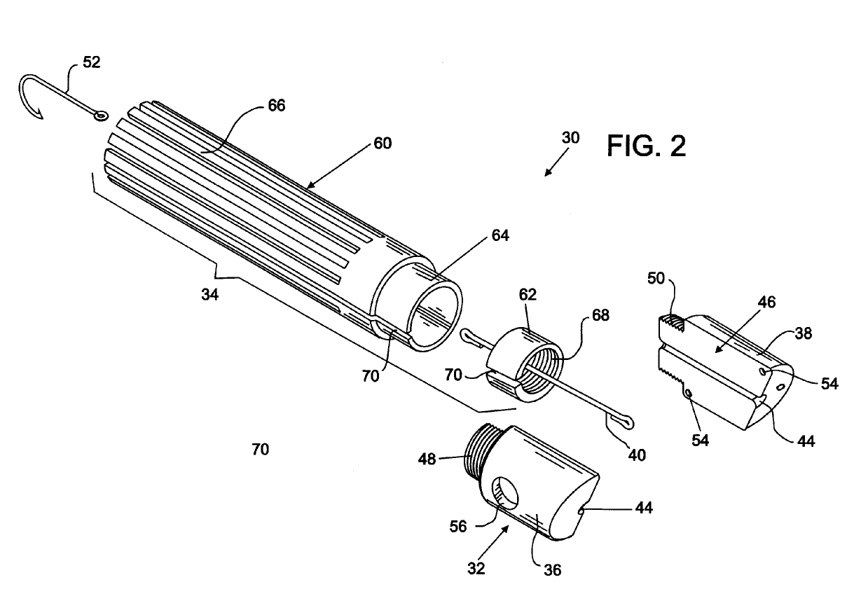

Referring now to the drawings, an embodiment of a fishing lure 30 according to the present invention is shown in FIG. 1 and FIG. 2. The lure 30 includes a head 32 and a rear portion 34. The head 32 may be cylindrical and may be split 35 into two or more parts 36, 38 longitudinally along the cylinder. A fishing line or leader 40, in this case a metal leader, passes through the lure 30, and specifically through an opening 42 in the head 32. The opening 42 in the head 32 is formed by opposing recesses or grooves 44 in opposing surfaces (only surface 46 is shown) of the head parts 36, 38. Although the surfaces 46 of the opposing head parts 36, 38 are shown as flat, they could have other profiles or be hollow so long as there are some opposing surfaces that meet to cause grooves to oppose and form an opening 42. The assembled head 32 has opposing threaded male half-cylinders 48, 50 at the rear end (towards a hook 52), which when placed together form a threaded male end. Except for the threaded male end, the head 32 need not have a cylindrical outer surface, but could be any shape as selected by one of ordinary skill in the art. One or more sockets 54 may be provided in the opposing surface 46 of a head part 38 to receive one or more tabs (not visible) in the opposing head part 36. The sockets 54 and tabs serve to maintain alignment of the head parts 36, 38. The head 32 shown may be referred to as an angled head because of the angled surface at the front of the head. A recess 56 may be provided to place a decorative eye. Adhesive-backed decorative designs may also be used on the lure 30.

The rear portion 34 includes a skirt 60, or streamers, and a skirt collar 62. The skirt 60 includes a skirt neck 64 and a skirt body 66. The skirt body 66 may be longitudinally split elastomeric material, as shown, or other material as known by one of ordinary skill in the art. The skirt collar 62 may be cylindrical and has a threaded female opening, or threaded bore 68. Further, the skirt collar may instead be a sleeve to which a lure body, or tail (not shown), for example, shaped like bait fish, may be attached. The skirt neck 64 and skirt collar 62 may have a longitudinal slit 70 through them as shown, or alternatively the slit 70 may be omitted such that the circumferences of the skirt collar and skirt neck are continuous. The skirt neck 64 is mounted to the skirt collar 62 using the resiliency of the skirt if the skirt neck is continuous, adhesive, both the resiliency and adhesive, or other means or combinations as known to one of ordinary skill in the art. This mounting may be done with the skirt 60 and skirt collar 62 off of the line or leader 40. More than one skirt 60 may be mounted to the skirt collar 62.

To assemble the lure 30, the assembled rear portion 34 may be placed around the fishing line or leader 40. The skirt collar 62 and hook 52 may be sized such that the skirt collar 62 can fit over the hook 52, but not through the central opening 42 in the head 32. Alternatively, where a slit 70 is provided, the rear portion 34 may be laterally placed around the leader 40 by passing the leader 40 through the slit 70. The head parts 36, 38 may then be assembled around the leader 40 to form the head 32. Then the threaded male end of the head and the threaded bore 62 of the skirt collar 62 may be screwed together, securing the head parts 36, 38 in close and complementary registration, providing a substantially tight interface that may hold the leader 40 in place and in the opening 42.

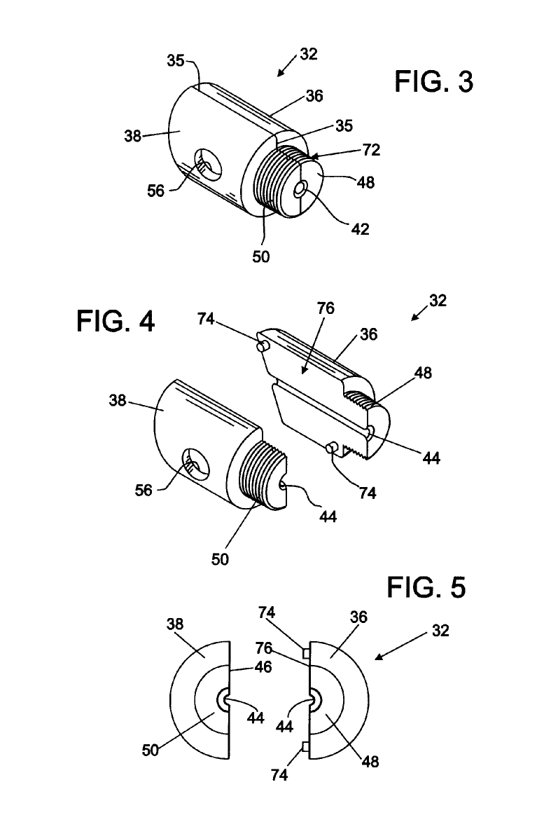

FIG. 3 shows the assembled head 32 and its cylindrical threaded male end 72. FIGS. 4 and 5 show the head 32 disassembled. Tabs 74, to be received in sockets 54 (FIG. 2) are provided for maintaining alignment of the head parts 36, 38. The substantially flat surface 76 of the head part 36 may be seen.

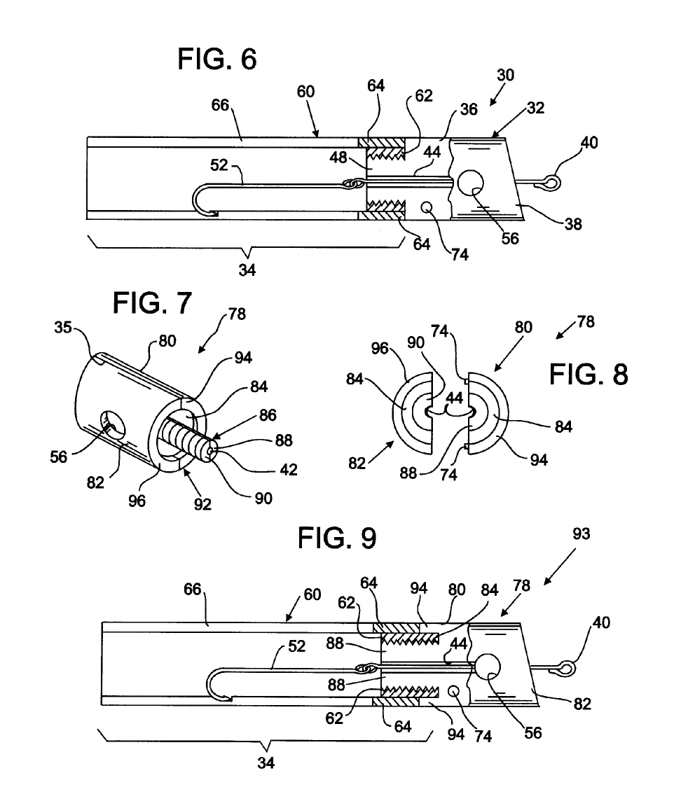

FIG. 6 shows the assembled lure 30 in partial section view. The head 32 and skirt collar 62 are screwed together, and the skirt neck 64 is mounted to the skirt collar 62. The skirt collar 62 may fit over the hook 52. The hook 52 and rear end of the leader 40 (end near the hook 52) do not fit through the opening 42 (FIG. 1) in the head 32 formed by the recessed areas 44. The lure 30 is free to slide forward until it meets an obstruction, such as the forward end (end away from the hook 52) of the leader 40. If fishing line passes through the head 32, the head 32 may be free to slide forward without obstruction, but will stay adjacent to the hook 52 as the result of being dragged through the water.

FIGS. 7 and 8 show an alternative embodiment of a head 78. The head 78 has two parts 80, 82 that when assembled make an annular recess 84 surrounding a male threaded end 86, also having two parts 88, 90. An annular extension 92, including two parts 94, 96, surrounds the recess 84. As shown in another embodiment of a lure 93 of FIG. 9, the annular recess 84 permits the skirt collar 62 to extend into the head 78. The annular extension 92 (one part 94 shown) provides support to the skirt collar 62, particularly when the skirt collar 62 is longitudinally slit and there may be a tendency for the collar 62 to open when force is applied. The annular extension 92 may prevent the collar 62 from opening.

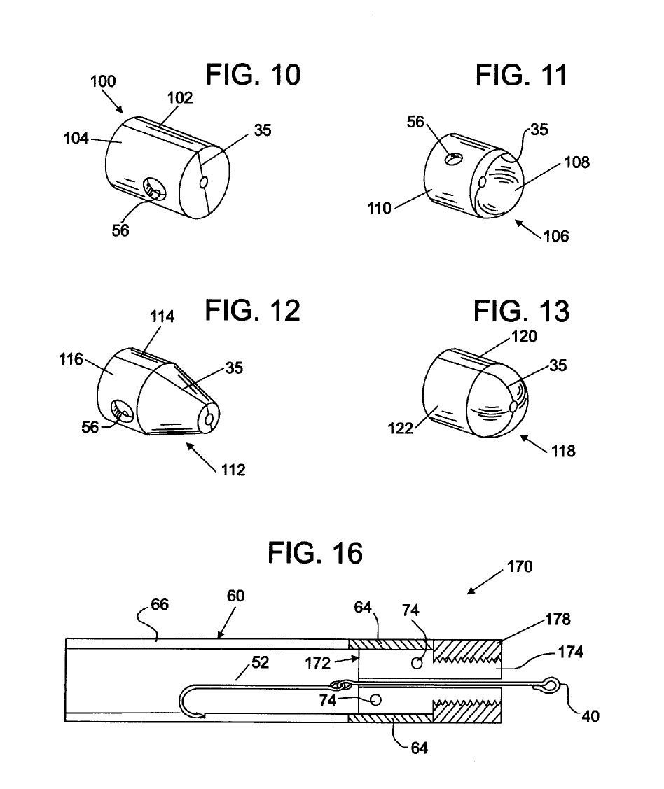

There is a variety of heads that may be provided in accordance with the present invention. For example, FIG. 10 shows a flat head 100 with two parts 102, 104; FIG. 11 shows a cup-shaped head 106 with two parts 108, 110; FIG. 12 shows a bullet head 112 with two parts 114, 116; and FIG. 13 shows a rounded head 118 with two parts 120, 122. The heads could be further segmented into more than two parts.

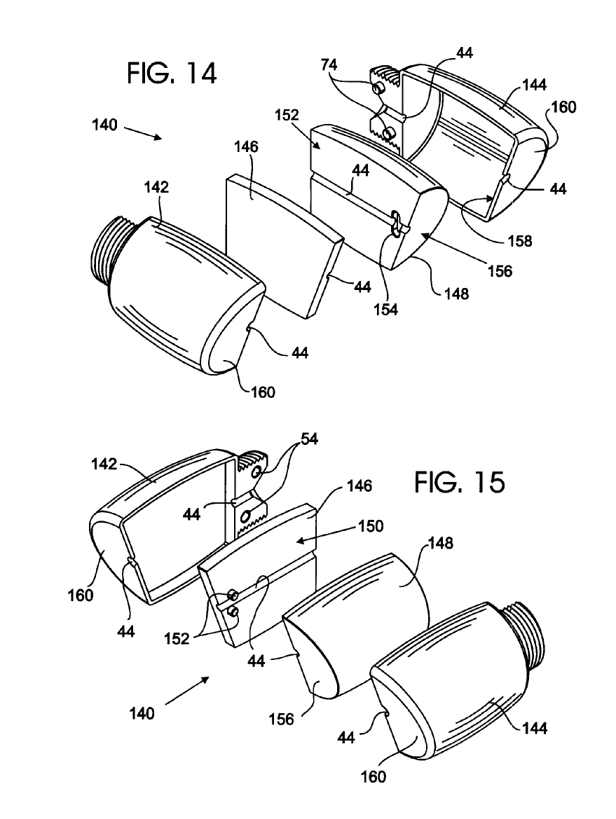

The interior of the heads may be hollow. Further, to provide lateral directional control, ballast may be placed inside of a hollow head, as shown in FIGS. 14 and 15. The head 140 is an angled head and includes two hollow halves 142, 144, a plate 146, and a ballast insert 148. The halves 142, 144 are mirror images of each other, except one half 144 has tabs 74 while the other half has sockets 54 for receiving the tabs 74. The exterior of the head 140 in this embodiment bulges outward, and is approximately oval-shaped longitudinally. The opposing surfaces 150, 152 of the plate 146 and the ballast insert 148 include grooves 44 that receive a fishing line or leader. The plate also has pins 152 that are received in a groove 154 in the ballast insert 148 and straddle the groove 44 for the fishing line or leader. The pins 152 secure the fishing line or leader in the groove 44; such a pin and groove arrangement could also be provided in previously described heads. The plate 146 and ballast insert 148 are reciprocally received in their respective halves 142, 144.

The ballast insert 148 is preferably metal, for example, lead or comparable material, but may also be plastic. The center of mass of the ballast insert 148 is offset from the longitudinal axis of the head 140 and lure. The ballast insert 148 causes there to be more weight on one half 144 of the head 140 than on the other half 142, which is hollow behind the plate 146, causing the half 144 with the ballast insert 148 to be below the other half 142 in the water. The angled face of the head 140 therefore is sideways in the water, resulting in lateral movement of the head 140 depending on which half of the head 140 the ballast insert 148 is located. This may be desirable so that the lure stays to one side or the other out of the back of a boat, avoiding the “propeller wash” that is the foamy water directly behind the boat, in which the line cannot be seen. In this embodiment of the head 140 the ballast insert 148 would direct the lure to the right when facing out the back of the boat. The sloped front surface 156 of the ballast insert 148 keeps the ballast insert in position, preventing rotation in the head 140, because the ballast insert fits in complementary registration with the sloped interior surface 158 of the head half 144. As an alternative to a plate 146, the half 142 in which the plate is received could be solid plastic, so long as there is a difference in weight between the two halves 142, 144, which would be the case if the ballast insert 148 is metal. The head's exterior front surface 160 should be angled or otherwise not symmetric to a plane perpendicular to the fishing line or leader in order for the head 140 to laterally direct the lure.

A non-split lure head may also be provided with ballast. As with the split-head lures with ballast previously discussed, the center of mass is offset from the longitudinal axis of the lure. This results in the same effect as in a split head, where the lure location is directed depending on the placement of the ballast and the profile of the front face of the head. The lure may have the same appearance as, for example, the assembled split lures of FIG. 3 and FIGS. 10-13, with the split 35 omitted. Alternatively, the lure could be any conventional shape with ballast included, with the ballast cast into the head, inserted into the head, or other design. The ballast could be placed at any desired location in the lure, such as in the head or the body.

An alternative embodiment of a lure 170 is shown in FIG. 16. This embodiment 170 includes a mounting cylinder that is split (with one part 172 shown) and has a threaded male end 174. The lure 170 also includes a skirt 60 or could include other artificial bait components, such as a body portion, or tail. The head includes a sleeve 178 that may be solid or slit to be laterally removable from the line or leader 40. To assemble the lure 170 the sleeve 178 may be placed over the hook and leader. The mounting cylinder halves 172 may be assembled around the leader 40 and then the mounting cylinder and sleeve 178 may be screwed together, securing the mounting cylinder.

The preferred lure type for given fish and conditions may be as determined by one of ordinary skill in the art. The interchangeable characteristic of the parts of the present invention allow replacement of all or part of the lure to achieve a desired combination while keeping the number of components lower than might be needed if using one-piece lures. For example, if there are six heads and six rear portions available, there are thirty-six possible combinations; thirty-six one-piece lures would be required to match the same possibilities.

Specific embodiments of an invention are described herein. One of ordinary skill in the art of fishing will recognize that the invention has other applications in other environments. In fact, many embodiments and implementations are possible. For example, the interchangeable design could be applied to fishing apparatus other than lures, such as sinkers. The head could be made of several parts rather than just the two shown in the Figures where the head is split. In addition, the recitation “means for” is intended to evoke a means-plus-function reading of an element in a claim, whereas, any elements that do not specifically use the recitation “means for,” are not intended to be read as means-plus-function elements, even if they otherwise include the word “means.” The following claims are in no way intended to limit the scope of the invention to the specific embodiments described.

What is claimed is:

1. A fishing lure for a fishing line or leader, comprising:
a first member including at least two parts including opposing surfaces having opposing recesses adapted to receive the fishing line or leader, the at least two parts including opposing portions that form a threaded cylindrical end of the first member, wherein the first member may be laterally applied to and removed from the fishing line or leader; and
a second member having a threaded bore therethrough, wherein the second member and the threaded end of the first member are screwed together to secure the parts in close and complementary registration and unscrewed to release the parts.

2. The fishing lure of claim 1, wherein the first member comprises a head and the second member comprises a skirt collar.

3. The fishing lure of claim 2, wherein the second member further comprises a skirt or tail.

4. The fishing lure of claim 2, wherein the head further comprises a ballast insert.

5. The fishing lure of claim 2, wherein at least one part of the head defines a first void, and the head further comprises a ballast insert in the first void, the ballast insert having a recess adapted to receive the fishing lure or leader.

6. The fishing lure of claim 5, wherein the part of the head opposing the ballast insert defines a second void, and the head further comprises a plate extending across the second void and opposing the ballast insert, the plate having a recess opposing the recess of the ballast insert and adapted to receive the fishing line or lure.

7. The fishing lure of claim 1, wherein the first member comprises a mounting cylinder and the second member comprises a head.

8. The fishing lure of claim 7, wherein the first member further comprises a skirt or tail.

9. The fishing lure of claim 1, wherein the first member has a central axis, the opposing recesses are aligned with the central axis, and laterally disposed surfaces of the at least two parts of the first member from the axis form a cylinder.

10. The fishing lure of claim 1, wherein the opposing recesses are sized such that an eyelet fastened to the fishing line, an eyelet of the leader, an eyelet of the hook, or combination thereof cannot pass therethrough.

11. The fishing lure of claim 10, wherein the threaded bore is adapted to allow a hook to pass axially therethrough.

12. The fishing lure of claim 1, wherein the second member has two ends and a slit extending between the two ends adapted to allow a fishing line or leader to pass laterally therethrough.

13. The fishing lure of claim 1, wherein the first member comprises an annular extension spaced from the threaded end to form an annular void, in which the second member is at least in part reciprocally disposed.

14. The fishing lure of claim 1, wherein the opposing surface of one part further comprises at least one tab in one portion and the opposing surface of the other part has at least one socket to reciprocally receive the at least one tab.

15. The fishing lure of claim 1, wherein the opposing surfaces are substantially flat and each part has an exterior surface that is substantially a portion of a circle and two ends, the opposing recesses are substantially a portion of a circle, the exterior surfaces form a cylinder, and the opposing recesses form an axial opening.

16. A fishing lure for a fishing line or leader, comprising:
a head including two parts, each part including a substantially flat surface, a substantially semicircular surface, and two ends, each flat surface having a substantially longitudinal semicircular recess, wherein one end of each part is threaded and the flat surfaces oppose each other to assemble the head and to form substantially a cylinder with the semicircular surfaces, a substantially axial cylindrical opening with the semicircular recesses, and a threaded cylindrical end, wherein the cylindrical opening is sized such that an eyelet fastened to the fishing line, an eyelet of the leader, an eyelet of the hook, or combination thereof cannot pass therethrough, and wherein the head may be laterally applied to and removed from the fishing line or leader; and
a rear portion including a cylindrical skirt collar having an axial, threaded bore therethrough and a skirt or tail, wherein the collar and the threaded end of the first member are screwed together to secure the parts in close and complementary registration and unscrewed to release the parts.

17. The fishing lure of claim 16, wherein the head further comprises a ballast insert.

18. The fishing lure of claim 16, wherein at least one part of the head defines a first void, and the head further comprises a ballast insert in the first void having a recess adapted to receive the fishing lure or leader.

19. The fishing lure of claim 18, wherein the part of the head opposing the ballast insert defines a second void, and the head further comprises a plate extending across the second void and opposing the ballast insert, the plate having a recess opposing the recess of the ballast insert and adapted to receive the fishing line or lure.

20. The fishing lure of claim 16, wherein the threaded bore is adapted to allow a hook to pass axially therethrough.

21. The fishing lure of claim 16, wherein the rear portion has two ends and a slit extending between the two ends adapted to allow a fishing line or leader to pass laterally therethrough.

22. The fishing lure of claim 16, wherein the head comprises an annular extension spaced from the threaded end, in which the skirt collar is at least in part reciprocally disposed.

23. A fishing lure for a fishing line or leader, comprising:
a rear portion including two parts and a skirt or tail, each part including a substantially flat surface, a substantially semicircular surface, and two ends, each flat surface having a longitudinal substantially semicircular recess, wherein one end of each part is threaded and the flat surfaces oppose each other to assemble the rear portion and to form substantially a cylinder with the semicircular surfaces, a substantially axial cylindrical opening with the semicircular recesses, and a threaded cylindrical end, wherein the cylindrical opening is sized such that an eyelet fastened to the fishing line, an eyelet of the leader, or an eyelet of the hook cannot pass therethrough; and
a head having an axial, threaded bore therethrough,
wherein the rear portion may be laterally applied to and removed from the fishing line or leader, and
wherein the head and the threaded end of the rear portion are screwed together to secure the parts in close and complimentary registration and unscrewed to release the parts.

24. The fishing lure of claim 23, wherein the threaded bore is adapted to allow a hook to pass axially therethrough.

25. The fishing lure of claim 23, wherein the rear portion has two ends and a slit extending between the two ends adapted to allow a fishing line or leader to pass laterally therethrough.

26. The fishing lure of claim 23, wherein the rear portion comprises an annular extension spaced from the threaded end, in which the head is at least in part reciprocally disposed.

27. A fishing lure for a fishing line or leader, wherein the lure has a longitudinal axis, comprising ballast disposed in the lure having a center of mass offset from the longitudinal axis of the lure.

28. The fishing lure of claim 27, further comprising a head in which the ballast is disposed.

29. The fishing lure of claim 27, further comprising a body in which the ballast is disposed.

30. A method of making a fishing lure to be applied to fishing line or a fishing leader, comprising:
providing a first member having a longitudinal axis and at least one cylindrical end;
threading the at least one cylindrical end of the first member;
forming an opening along the longitudinal axis;
cutting the first member into at least two parts along the longitudinal axis;
providing a second member having a bore therethrough and two ends; and
threading the bore.

31. The method of making a fishing lure of claim 30, wherein providing a second member having a bore therethrough further comprises providing a second member having a bore adapted to allow a hook to pass axially therethrough.

32. The method of making a fishing lure of claim 30, further comprising forming a slit in the second member extending between the two ends, adapted to allow the fishing line or leader to pass laterally therethrough.

33. A method of attaching a fishing lure for a fishing line or leader, comprising:
laterally placing around the fishing line or leader a first member including at least two parts including opposing surfaces having opposing recesses adapted to receive the fishing line or leader, the two parts including opposing portions that form a threaded cylindrical end of the first member;
placing a second member having a threaded bore therethrough around the fishing line or leader;
screwing the threaded end of the first member and the second member together, securing the parts in close and complementary registration.

34. The method of claim 33, further comprising unscrewing the threaded end of the first member and the second member, releasing the at least two parts and allowing disassembly of the first member laterally from the fishing line or leader.

35. The method of claim 33, further comprising inserting a ballast insert in at least one part of the first member.
